(19) United States
(12) Patent Application Publication
(10) Pub. No.: US 2025/0374227 A1
(43) Pub. Date: Dec. 4, 2025

(54) ELECTRONIC DEVICE, METHOD, AND NON-TRANSITORY STORAGE MEDIUM FOR MEASURING TRANSMISSION LOCATION OF WIRELESS SIGNAL

(71) Applicant: SAMSUNGELECTRONICS CO., LTD., Suwon-si (KR)

(72) Inventors: Youngbae JEON, Suwon-si (KR); Bumjun KWON, Suwon-si (KR); Jeongyoon HEO, Suwon-si (KR); Choonghoon LEE, Suwon-si (KR)

(73) Assignee: SAMSUNGELECTRONICS CO., LTD., Suwon-si (KR)

(21) Appl. No.: 19/222,576

(22) Filed: May 29, 2025

Related U.S. Application Data
(63) Continuation of application No. PCT/KR2025/007278, filed on May 28, 2025.

(30) Foreign Application Priority Data
May 29, 2024 (KR) 10-2024-0070179

(51) Int. Cl. H04W 64/00; G01S 11/04; G01S 11/06

(52) U.S. Cl. CPC H04W 64/00; G01S 11/04; G01S 11/06

(57) ABSTRACT

An electronic device and method for determining target device location includes receiving a wireless signal from a target device; acquiring first information from an external device at a first location; determining a first distance value between the first location and the electronic device's fixed location by instructing the external device to be in a first direction; acquiring a first angle of arrival; acquiring second information from the external device at a second location; determining a second distance value by instructing the external device to be in a different second direction; acquiring a second angle of arrival; acquiring three-dimensional location information based on both angles of arrival; and identifying the target device's location.

### CROSS-REFERENCE TO RELATED APPLICATION

This application is a by-pass continuation application of International Application No. PCT/KR2025/007278, filed on May 28, 2025, which is based on and claims priority to Korean Patent Application No.: 10-2024-0070179 filed on May 29, 2024, in the Korean Patent Office, the disclosures of which are incorporated by reference herein in their entireties.

### 1. FIELD

The present disclosure relates to an electronic device, a method, and a non-transitory storage medium for measuring a transmission location of a wireless signal

### 2. DESCRIPTION OF RELATED ART

With the development of digital technologies, electronic devices are being provided in various forms, such as a smartphone, a tablet personal computer (PC), or a personal digital assistant (PDA). Electronic devices are also being developed in a wearable form for users so as to improve portability and accessibility for the users.

Various electronic devices are provided to users, and electronic devices may be connected to external electronic devices based on wireless communication schemes for connection, so as to transmit wireless signals to the external electronic devices, receive wireless signals from the external electronic devices, and perform positioning. Various wireless communication schemes include, for example, an ultra-wideband (UWB) communication scheme, a wireless fidelity (Wi-Fi) communication scheme, and a Bluetooth (BT) communication scheme.

The above-described information may be provided as related art for the purpose of assisting in understanding the disclosure. No assertion or decision is made as to whether any of the above might be applicable as prior art with regard to the disclosure.

### SUMMARY

According to an aspect of the disclosure, an electronic device includes an antenna circuit; a communication circuit; memory storing one or more instructions; and at least one processor configured to execute the one or more instructions to: receive a wireless signal transmitted based on a wireless communication scheme by a target electronic device; acquire first information associated with the wireless signal received by an external electronic device at a first location; determine a first distance value between the first location of the external electronic device and a fixed location of the electronic device, by instructing the external electronic device to be located at the first location in a first direction; acquire a first angle of arrival, based on the first distance value and the first information; acquire second information associated with the wireless signal received by the external electronic device at a second location; determine a second distance value between the second location of the external electronic device and the fixed location of the electronic device, by instructing the external electronic device to be located at the second location in a second direction that is different from the first direction; acquire a second angle of arrival, based on the second distance value and the second information; acquire, based on the first angle of arrival and the second angle of arrival, three-dimensional location information corresponding to a transmission location of the wireless signal transmitted by the target electronic device; identify a location of the target electronic device based on the three-dimensional location information.

The at least one processor may be configured to provide a first message instructing the external electronic device to be located at the first location in the first direction; and provide a second message instructing the external electronic device to be located at the second location in the second direction.

The antenna circuit may comprise a single antenna, wherein the single antenna may be configured to receive the wireless signal transmitted by the target electronic device and measure the transmission location of the wireless signal, wherein the wireless signal may be a Wi-Fi signal or a Bluetooth signal, and wherein the external electronic device may be a wearable device or a mobile wireless communication device comprising a single antenna that is configured to receive the wireless signal and measure the transmission location of the wireless signal.

The electronic device may further include a display, wherein the at least one processor may be further configured to identify the location of the target electronic device, based on the three-dimensional location information, and control the display to display an execution screen comprising a graphic object indicating the identified location of the target electronic device.

The electronic device may further include an audio output circuit, wherein the at least one processor may be further configured to identify the location of the target electronic device, based on the three-dimensional location information, and control the audio output circuit to output speech information indicating the identified location of the target electronic device.

The first direction may correspond to an x-axis direction or a horizontal direction, based on the fixed location of the electronic device, and wherein the second direction may correspond to a y-axis direction or a vertical direction, based on the fixed location.

The first information may comprise at least one of identification information, phase information, a signal measurement time, or a signal strength of the wireless signal received at a first time point at the first location of the external electronic device, and wherein the second information may comprise at least one of identification information, phase information, a signal measurement time, or a signal strength of the wireless signal received at a second time point at the second location of the external electronic device.

The at least one processor may be further configured to acquire the first angle of arrival based on at least one of a time difference, a phase difference, a signal speed, or the first distance value; and acquire the second angle of arrival based on at least one of a time difference, a phase difference, a signal speed, or the second distance value.

The first distance value and the second distance value may be acquired based on a received signal strength indicator (RSSI).

According to an aspect of the disclosure, an operation method of an electronic device includes receiving a wireless signal transmitted based on a wireless communication scheme by a target electronic device; acquiring first information associated with the wireless signal received by an external electronic device at a first location; determining a first distance value between the first location of the external electronic device and a fixed location of the electronic device, by instructing the external electronic device to be located at the first location in a first direction; acquiring a first angle of arrival, based on the first distance value and the first information; acquiring second information associated with the wireless signal received by the external electronic device at a second location; determining a second distance value between the second location of the external electronic device and the fixed location of the electronic device, by instructing the external electronic device to be located at the second location in a second direction that is different from the first direction; acquiring a second angle of arrival, based on the second distance value and the second information; acquiring, based on the first angle of arrival and the second angle of arrival, three-dimensional location information corresponding to a transmission location of the wireless signal transmitted by the target electronic device; identifying a location of the target electronic device based on the three-dimensional location information.

The method may further include providing a first message instructing the external electronic device to be located at the first location in the first direction; and providing a second message instructing the external electronic device to be located at the second location in the second direction.

The wireless signal may be received via a single antenna of the electronic device, wherein the single antenna may be configured to measure the transmission location of the wireless signal, wherein the wireless signal may be a Wi-Fi signal or a Bluetooth signal, and wherein the external electronic device may be a wearable device or a mobile wireless communication device comprising a single antenna that is configured to receive the wireless signal and measure the transmission location of the wireless signal.

The method may further include identifying the location of the target electronic device, based on the three-dimensional location information; and displaying an execution screen comprising a graphic object indicating the identified location of the target electronic device on a display of the electronic device.

The method may further include identifying the location of the target electronic device, based on the three-dimensional location information; and outputting speech information indicating the identified location of the target electronic device via an audio output circuit of the electronic device.

The first direction may correspond to an x-axis direction or a horizontal direction based on the fixed location of the electronic device, and wherein the second direction may correspond to a y-axis direction or a vertical direction, based on the fixed location.

The first information may comprise at least one of identification information, phase information, a signal measurement time, or a signal strength of the wireless signal received at a first time point at the first location of the external electronic device, and wherein the second information may comprise at least one of identification information, phase information, a signal measurement time, or a signal strength of the wireless signal received at a second time point at the second location of the external electronic device.

The acquiring of the first angle of arrival may include acquiring the first angle of arrival based on at least one of a time difference, a phase difference, a signal speed, or the first distance value.

The acquiring of the second angle of arrival may include acquiring the second angle of arrival based on at least one of a time difference, a phase difference, a signal speed, or the second distance value.

The first distance value and the second distance value may be acquired based on a received signal strength indicator (RSSI).

According to an aspect of the disclosure, a non-transitory storage medium for storing one or more instructions which, when executed by at least one processor of an electronic device, cause the electronic device to perform: receiving a wireless signal transmitted based on a wireless communication scheme by a target electronic device; acquiring first information associated with the wireless signal received by an external electronic device at a first location; determining a first distance value between the first location of the external electronic device and a fixed location of the electronic device, by instructing the external electronic device to be located at the first location in a first direction; acquiring a first angle of arrival, based on the first distance value and the first information; acquiring second information associated with the wireless signal received by the external electronic device at a second location; determining a second distance value between the second location of the external electronic device and the fixed location of the electronic device, by instructing the external electronic device to be located at the second location in a second direction that is different from the first direction; acquiring a second angle of arrival, based on the second distance value and the second information; acquiring, based on the first angle of arrival and the second angle of arrival, three-dimensional location information corresponding to a transmission location of the wireless signal transmitted by the target electronic device; identifying a location of the target electronic device based on the three-dimensional location information.

### BRIEF DESCRIPTION OF DRAWINGS

The above and other aspects, features, and advantages of certain embodiments of the present disclosure are more apparent from the following description taken in conjunction with the accompanying drawings, in which:

FIG. 1 is a block diagram of an electronic device in a network environment according to various embodiments;

FIG. 2 is a diagram illustrating a structure of the electronic device according to an embodiment;

FIG. 3 is a diagram illustrating an example for estimating a location of a wireless signal by the electronic device according to an embodiment;

FIG. 4A and FIG. 4B are diagrams illustrating an example for estimating a location of a wireless signal by the electronic device according to an embodiment;

FIG. 5 shows diagrams illustrating an example of screens for estimating a location of a wireless signal by the electronic device according to an embodiment;

FIG. 6 is a diagram illustrating an example of a screen for estimating a location of a wireless signal by the electronic device according to an embodiment;

FIG. 7 is a diagram illustrating an example of an operation method of an electronic device according to an embodiment; and

FIG. 8 is a diagram illustrating an example of an operation method of an electronic device according to an embodiment.

### With regard to the description of the drawings, the same or like reference signs may be used to designate the same or like elements.

### DETAILED DESCRIPTION

The embodiments described in the disclosure, and the configurations shown in the drawings, are only examples of embodiments, and various modifications may be made without departing from the scope and spirit of the disclosure.

Embodiments of the disclosure will be described in detail with reference to the drawings so that those skilled in the art to which the disclosure pertains can easily implement the disclosure. The disclosure may be implemented in various forms and is not limited to embodiments set forth herein. With regard to the description of the drawings, the same or like reference signs may be used to designate the same or like elements. Also, in the drawings and the relevant descriptions, description of well-known functions and configurations may be omitted for the sake of clarity and brevity. As used in various embodiments, the term “user” may refer to a person who uses an electronic device or a device (e.g., artificial intelligence electronic device) which uses an electronic device.

The expressions “at least one of A, B and C” and “at least one of A, B, or C”, both indicate “A”, only “B”, only “C”, both “A and B”, both “A and C”, both “B and C”, and all of “A, B, and C”.

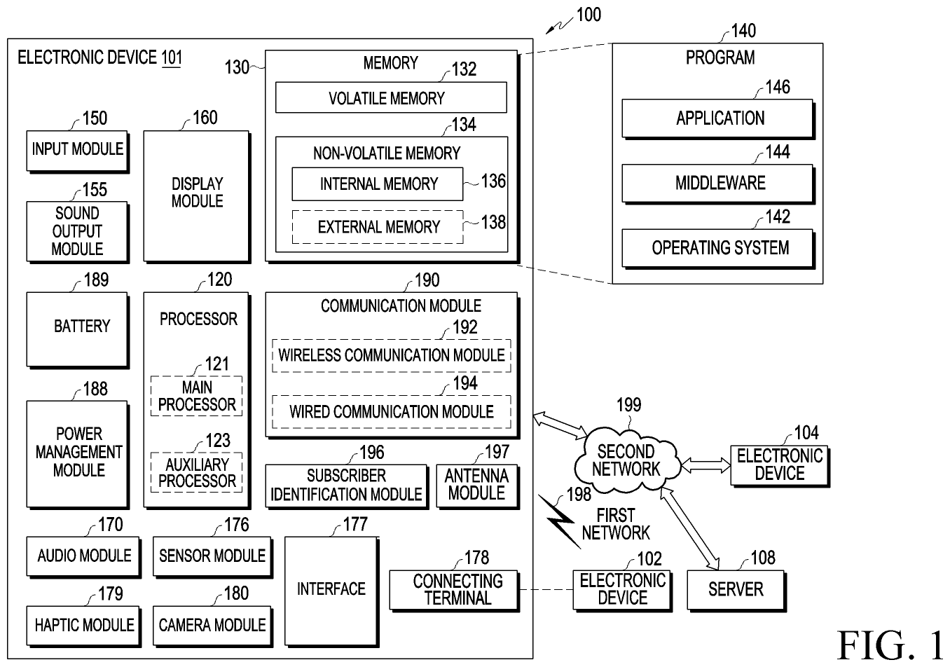

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

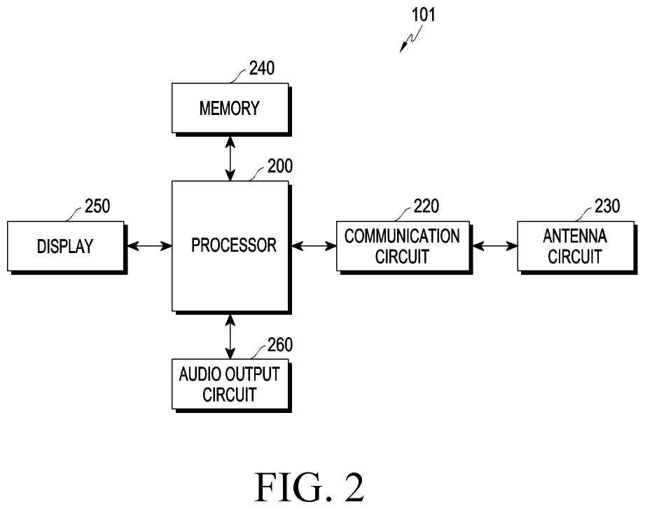

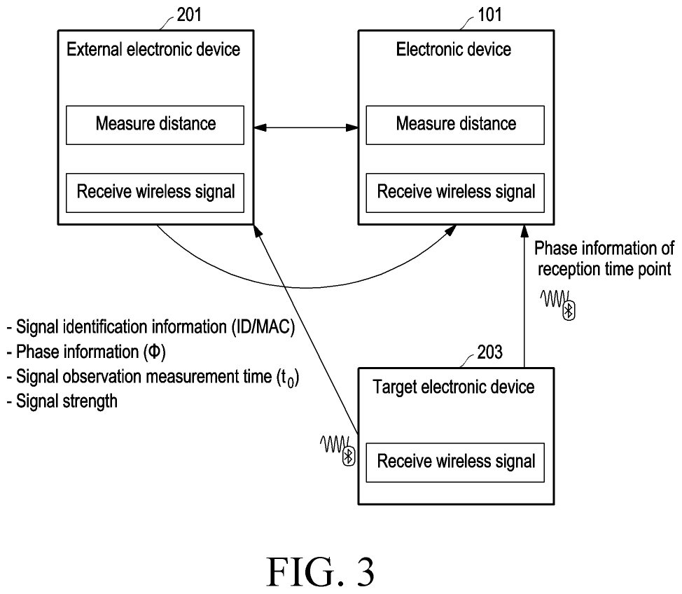

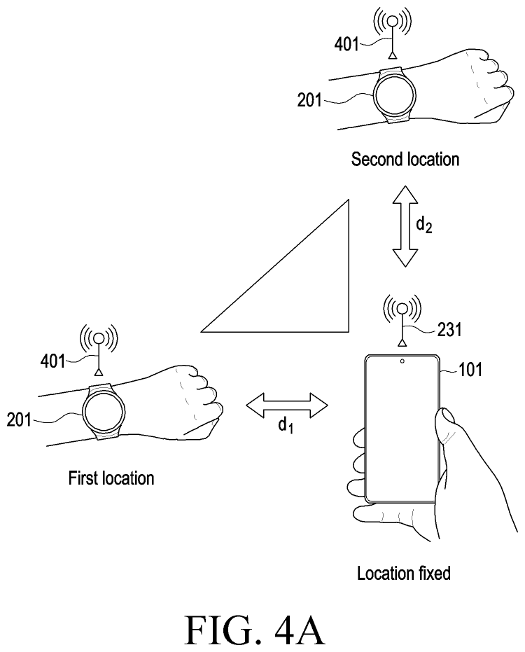

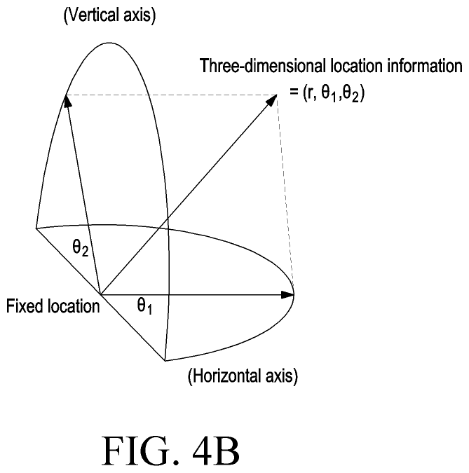

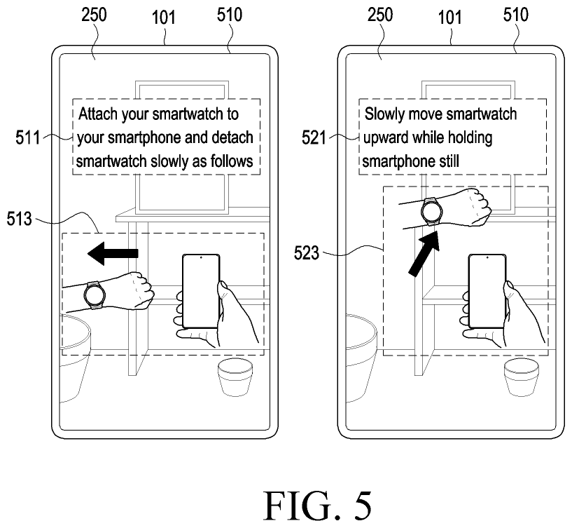

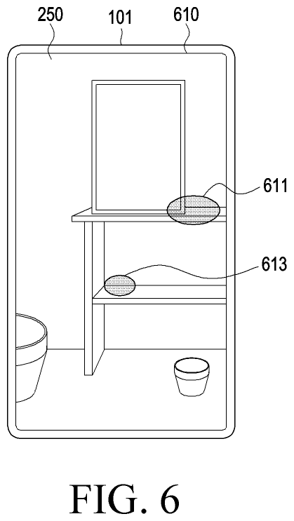

FIG. 2 is a diagram illustrating a structure of a wireless signal in the electronic device according to an embodiment. FIG. 3 is a diagram illustrating an example for measuring a transmission location of a wireless signal by the electronic device according to an embodiment. FIG. 4A and FIG. 4B are diagrams illustrating an example for measuring a transmission location of a wireless signal by the electronic device according to an embodiment. FIG. 5 shows diagrams illustrating an example of screens for measuring a transmission location of a wireless signal by the electronic device according to an embodiment. FIG. 6 is a diagram illustrating an example of a screen for measuring a transmission location of a wireless signal by the electronic device according to an embodiment.

Referring to FIGS. 2, 3, 4, 5, and 6, the electronic device 101 (e.g., the electronic device 101 of FIG. 1) according to an embodiment may include a processor 210 (e.g., the processor 120 of FIG. 1), a communication circuit 220 (e.g., the wireless communication module 192 of FIG. 1), an antenna circuit 230 (e.g., the antenna module 197 of FIG. 1), memory 240 (e.g., the memory 130 of FIG. 1), a display 250 (e.g., the display module 150 of FIG. 1), and an audio output circuit (e.g., the audio output module 155 of FIG. 1). Without being limited thereto, the electronic device may further include other components illustrated in FIG. 1. According to an embodiment, the electronic device 101 may use an external electronic device 201 to position (e.g., identify, measure, detect, or estimate) a transmission location of a wireless signal transmitted from a target electronic device 203. The electronic device 101 may communicate with the external electronic device 201 and the target electronic device 203 based on a wireless communication scheme (e.g., a Wi-Fi communication scheme or a Bluetooth communication scheme) via the communication circuit 220. Here, the external electronic device 201 may be a wearable device or mobile wireless communication device (e.g., a portable device or home appliance capable of Wi-Fi or Bluetooth communication) including a single antenna for positioning. The wireless signal may be a Wi-Fi signal or a Bluetooth signal.

According to an embodiment, the processor 210 may be operatively connected to the communication circuit 220, the antenna circuit 230, the memory 240, and the display 250, and may be operatively connected to other components necessary for measuring a transmission location of a wireless signal.

According to an embodiment, in response to a request for measuring the transmission location of the wireless signal transmitted by the target electronic device 203 so as to estimate a location of the target electronic device 203, the processor 210 may execute an application related to positioning and may control the display 250 to display execution screens 510, 520, and/or 610 related to measuring of the transmission location of the wireless signal.

According to an embodiment, in response to the request for measuring the transmission location of the wireless signal, the processor 210 may control the communication circuit 230 to receive, via a single antenna 231, the wireless signal transmitted from the target electronic device 203, and may control the communication circuit 230 to communicate with the external electronic device 201 that receives the same wireless signal. According to an embodiment, the processor 210 may control the single antenna 231 included in the antenna module 230 so as to be used to measure the transmission location of the wireless signal. Here, the antenna module 230 may include one antenna or include multiple antennas, and when multiple antennas are included, one of the multiple antennas may be used to measure the transmission location of the wireless signal. According to an embodiment, when the wireless signal transmitted by the target electronic device 203 is received via the single antenna 231, the processor 210 may receive, in real time from the external electronic device 201 which receives the wireless signal at the same time, information (e.g., first information and second information) on a wireless signal, which is used for measuring an angle of arrival (AOA). Here, the information on the wireless signal is physical layer information of a low level and may include at least one of reception identification information (e.g., ID or MAC), a reception time to, phase information, or a signal strength of the wireless signals. According to an embodiment, the external electronic device 201 may periodically acquire and store information on wireless signals, and transmit the same to the electronic device 101 periodically or upon a request of the electronic device 101 (e.g., when measuring an AOA or when measuring a distance).

According to an embodiment, as illustrated in FIG. 3, the processor 210 may induce (e.g., instruct) the external electronic device 201 to be located at a first location in a first direction (e.g., the horizontal direction or the x-axis direction) based on a fixed location of the electronic device 101. The processor 210 may control the display 250 to display, on the execution screen 510, a message 511 (e.g., “attach your smartwatch to your smartphone and move the smartwatch slowly as follows”) and/or an image 513 which induce the external electronic device 201 to be located at the first location in the first direction. According to an embodiment, the processor 210 may control an audio output module (e.g., the audio output module 155 of FIG. 1) to output, as speech information, the message that induces the external electronic device 201 to be located at the first location in the first direction. According to an embodiment, the processor 210 may transmit, to the external electronic device 201 via the communication circuit 230, the message that induces the external electronic device 201 to be located at the first location in the first direction. Without being limited thereto, the processor 210 may induce the message to be located at the first location in the first direction by using vibration or light.

According to an embodiment, as illustrated in FIG. 4A, the processor 210 may, based on the external electronic device 201 being located at the first location in the first direction, receive first information on a wireless signal received at the first location at a first time point from the external electronic device 201, and acquire a first distance value d1 between the first location and a fixed location of the electronic device 101 (e.g., between the single antenna 231 of the electronic device 101 and a single antenna 401 of the external electronic device 201). The processor 210 may use, for example, a received signal strength indicator (RSSI) to measure an amount of output power being decreased from when the wireless signal is transmitted from the target electronic device 203 to when the electronic device 101 receives the wireless signal, thereby acquiring the first distance value. The processor 210 may acquire the first distance value by using, for example, an IMU sensor. Here, a scheme of using a received signal strength indicator (RSSI) uses signal strength attenuation being constant according to distances, and is a scheme having a small distance measurement error when a radius is within 1 m.

According to an embodiment, as illustrated in FIG. 4A and FIG. 4B, the processor 210 may measure (e.g., acquire, calculate, or identify) a first AoA θ1 based on the first distance value d1 and first information on the wireless signal received from external electronic device 201. Here, as illustrated in FIG. 4B, the first AoA may be an angle between a reference direction and a direction (e.g., the first direction) in which the wireless signal received at the first time point via the single antenna 401 of the external electronic device 201 at the first location in the first direction (e.g., the horizontal axis or the x-axis) arrives. The processor 210 may acquire the first AoA θ1 by using a time difference Δt (e.g., a difference between a time for arrival at the single antenna of the external electronic device and a time for arrival at the single antenna of the electronic device) or a phase difference, a signal speed c, and the first distance value d1 for the wireless signal received at the first location at the first time point. The first AoA θ1 may be calculated using the following <Equation 1>.

$$θ 1 = {sin}^{- 1} ( \frac{c \cdot Δ t}{d 1} ) \qquad [ Equation l ]$$

According to an embodiment, as illustrated in FIG. 3, the processor 210 may induce the external electronic device 201 to move to or be located at a second location in a second direction (e.g., the vertical direction or the y-axis direction) different from the first direction based on the fixed location of the electronic device 101. The processor 210 may control the display 250 to display, on the execution screen 520, a message 521 (e.g., “slowly move the smartwatch upward while holding the smartphone still”) and/or an image 523 which induce the external electronic device 201 to be located at the second location in the second direction. According to an embodiment, the processor 210 may control the audio output module (e.g., the audio output module 155 of FIG. 1) to output, as speech information, the message that induces the external electronic device 201 to be located at the second location in the second direction. According to an embodiment, the processor 210 may transmit, to the external electronic device 201 via the communication circuit 230, the message that induces the external electronic device 201 to be located at the second location in the second direction. Without being limited thereto, the processor 210 may induce the message to be located at the second location in the second direction by using vibration or light. Here, the electronic device 101 (e.g., the antenna 231 of the electronic device 101) may have the fixed location, and the external electronic device 201 (e.g., the single antenna 401 of the external electronic device 201) may have a location that is not fixed, and have a location that changes, for example, from the first location to the second location for two location measurements.

According to an embodiment, the processor 210 may acquire second information on a wireless signal received at the second location at a second time point by the external electronic device 201, and acquire a second distance value d2 between the second location and the fixed location of the electronic device 101 (e.g., between the antenna 231 of the electronic device 101 and the antenna 201 of the external electronic device 201). The processor 210 may use, for example, a received signal strength indicator (RSSI) to measure an amount of output power being decreased from when the wireless signal is transmitted from the target electronic device 203 to when the electronic device 101 receives the wireless signal, thereby acquiring the second distance value. The processor 210 may acquire the second distance value by using, for example, the IMU sensor.

According to an embodiment, the processor 210 may acquire a second AoA θ2 based on the second distance value and the second information. Here, as illustrated in FIG. 4B, the second AoA may be an angle between the reference direction and a direction (e.g., the second direction) in which the wireless signal received at the second time point via the single antenna 401 of the external electronic device 201 at the second location in the second direction (e.g., the vertical axis or the y-axis) arrives. The processor 210 may acquire the second AoA θ2 by using a time difference Δt (e.g., a difference between a time for arrival at the single antenna of the external electronic device and a time for arrival at the single antenna of the electronic device) or a phase difference, a signal speed c, and the second distance value d2 for the wireless signal received at the second location at the second time point. The second AoA θ2 may be calculated using the following <Equation 2>.

$$θ 2 = {sin}^{- 1} ( \frac{c \cdot Δ t}{d 2} ) \qquad [ Equation 2 ]$$

According to an embodiment, the processor 210 may measure, based on the first AoA and the second AoA, a transmission location of the wireless signal transmitted from the target electronic device 203 so as to estimate a location of the target electronic device 203. The processor 210 may acquire three-dimensional location information (e.g., a spherical coordinate system (r, θ1, θ2)) of the direction in which the wireless signal is transmitted. The processor 210 may estimate the location of the target electronic device 203 based on the three-dimensional location information (e.g., the spherical coordinate system (r, θ1, θ2)) corresponding to the transmission location of the wireless signal. According to an embodiment, as illustrated in FIG. 6, the processor 210 may control the display 250 to display, on the execution screen 610, a graphic object 611 or 613 (e.g., text or symbol) indicating the three-dimensional location information (e.g., the spherical coordinate system (r, θ1, θ2)) or the estimated location of the target electronic device 203. Without being limited thereto, the electronic device according to an embodiment may provide, as speech information, the estimated location of the target electronic device. According to an embodiment, the processor 210 may transmit the acquired three-dimensional location information (e.g., the spherical coordinate system (r, θ1, θ2)) to the external electronic device (e.g., the electronic device 102 or 104 or the server 108 of FIG. 1 or the external electronic device 201 of FIG. 2). According to an embodiment, the external electronic device may provide the estimated location of the target electronic device 203 (e.g., display the graphic object indicating the estimated location or output the speech information), based on the received three-dimensional location information.

According to an embodiment, the processor 210 is a hardware module or a software module (e.g., an application program), and may be a hardware component (function) or a software element (program) including at least one of various components provided in the electronic device 201. According to an embodiment, the processor 210 may include, for example, one or a combination of two or more of hardware, software, and firmware. The processor 210 may omit at least some of the components, or may further include, in addition to the components, other components for performing image processing.

According to an embodiment, the communication circuit 220 may communicate with an external electronic device (e.g., the electronic device 102 or 104 of FIG. 1, the server 108 of FIG. 1, or the external electronic device 201 of FIG. 2) and a target electronic device (e.g., the target electronic device 203 of FIG. 2) by using a wireless communication scheme (e.g., a Wi-Fi scheme or a Bluetooth scheme). The communication circuit 220 may receive a wireless signal (e.g., a Wi-Fi signal or a Bluetooth signal) in the wireless communication scheme from the target electronic device 203. The communication circuit 220 may receive, from the external electronic device 201 via the wireless communication scheme, information on the wireless signal received by the external electronic device 201 from the target electronic device 203. According to an embodiment, the communication module 220 may include a wireless-fidelity (Wi-Fi) circuit or a Bluetooth circuit.

According to an embodiment, the antenna circuit 230 may be electrically connected to the communication circuit 220, and may be operatively connected to the processor 210 so as to transmit or receive a wireless signal processed by the communication circuit 220. According to an embodiment, the antenna circuit 230 may include the single antenna 231 or multiple antennas including the single antenna 231. Here, the single antenna 231 may be used to measure a transmission location of a wireless signal transmitted from the target electronic device 203. According to an embodiment, at least one antenna other than the single antenna 231 among the multiple antennas may be configured not to be used to measure a transmission location of a wireless signal.

The memory 240 according to an embodiment (e.g., the memory 130 of FIG. 1) may store an application (function or program) related to positioning, an application related to wireless communication, and/or other applications related to operations of the disclosure. The memory 240 according to an embodiment may store, in addition to a program (e.g., the program 140 of FIG. 1) used for a function operation, various data generated during execution of the program 140. According to an embodiment, the memory 240 may mainly include the program area 140 and a data area (not illustrated). The program area 140 may store related program information for driving the electronic device 101, such as an operating system (OS) (e.g., the operating system 142 of FIG. 1) that boots the electronic device 101. The data area (not illustrated) may store transmitted and/or received data and generated data according to various embodiments. The memory 240 may include at least one storage medium among flash memory, a hard disk, multimedia card micro-type memory (e.g., secure digital (SD) or extreme digital (XD) memory), RAM, and ROM. According to an embodiment, the memory 240 may store information related to measuring of a transmission location of a wireless signal.

According to an embodiment, the display 250 may be implemented in the form of a touch screen. When the display 250 is implemented with an input module in the form of a touch screen, various information generated according to a touch action of a user may be displayed. According to an embodiment, the display 250 may display various execution screens related to measuring of a transmission location of a wireless signal. According to an embodiment, the display 250 may display a first message (e.g., the message 511 of FIG. 5) and/or an image (e.g., the image 513 of FIG. 5) which induces the external electronic device 201 to be located at a first location in a first direction. According to an embodiment, the display 250 may display a second message (e.g., the message 521 of FIG. 5) and/or an image (e.g., the image 523 of FIG. 5) which induces the external electronic device 201 to be located at a second location in a second direction. According to an embodiment, the display 250 may identify (or estimate) a location of the target electronic device based on three-dimensional location information, and display an execution screen including a graphic object indicating the three-dimensional location information or the identified (or estimated) location. According to an embodiment, the display 250 may include at least one of a liquid crystal display (LCD), a thin film transistor LCD (TFT-LCD), an organic light emitting diode (OLED), a light emitting diode (LED), an active-matrix organic LED (AMOLED), a flexible display, and a three-dimensional display. Some of these displays may be configured to be transparent or light-transmissive so that the outside can be viewed therethrough. These displays may be configured in the form of a transparent display including a transparent OLED (TOLED). According to another embodiment, in addition to the display 250, another mounted display circuit (e.g., an extended display or a flexible display) may be further included.

According to an embodiment, an audio output circuit 260 may output, as speech information, a first message that induces the external electronic device 201 to be located at a first location in a first direction. According to an embodiment, the audio output circuit 260 may output, as speech information, a second message that induces the external electronic device 201 to be located at a second location in a second direction. According to an embodiment, the audio output circuit 260 may output speech information indicating a location of the target electronic device 203, which is identified based on three-dimensional location information.

According to another embodiment, when the electronic device 101 is capable of moving from the first location to the second location, and the external electronic device 201 that receives the wireless signal transmitted from the target electronic device 203 has a fixed location, the electronic device 101 may perform the operation of the external electronic device 201 according to the aforementioned embodiment in order to measure the transmission location of the wireless signal, and the external electronic device 201 may perform the operation of the electronic device 101 for measuring the transmission location of the wireless signal according to the aforementioned embodiment in order to measure the transmission location of the wireless signal. According to another embodiment, when the electronic device 101 is capable of moving from the first location to the second location, and performs wireless communication with another electronic device (not illustrated) (e.g., an electronic device capable of performing Wi-Fi or Bluetooth communication) at a fixed location, and the another electronic device does not include a configuration for measuring the transmission location of the wireless signal, the electronic device 101 capable of moving from the first location to the second location may measure (or acquire) a first AoA and a second AoA, and acquire three-dimensional location information based on the first AoA and the second AoA, as in the aforementioned embodiment. According to another embodiment, the electronic device 101 may periodically acquire information on a wireless signal received via the single antenna 231 and store the same in the memory 240, acquire, from the memory 240, first information for measuring (or acquiring) the first AoA, and acquire, from the memory 240, second information for measuring (or acquiring) the second AoA.

An electronic device (e.g., the electronic device 101 of FIGS. 1 to 6) according to an embodiment may implement a software module (e.g., the program 140 of FIG. 1) configured to estimate a location of a wireless signal of a target electronic device. Memory (e.g., the memory 130 of FIG. 1 and the memory 240 of FIG. 2) of the electronic device may store instructions to implement the software module. At least one processor (e.g., the processor 120 of FIG. 1 and the processor 210 of FIG. 2) may execute the instructions stored in the memory to implement the software module, and may control hardware (e.g., the communication module 190, the antenna module 197, and the display module 160 of FIG. 1) associated with functions of the software module.

The software module of the electronic device according to an embodiment may include a kernel (or HAL), a framework (e.g., the middleware 144 of FIG. 1) 220, and an application (e.g., the application 146 of FIG. 1). At least a part of the software module may be preloaded on the electronic device 101 or may be downloaded from a server (e.g., the server 108).

According to an embodiment, the kernel may include, for example, a system resource manager or a device driver, and without being limited thereto, the kernel may further include other modules. The system resource manager may perform control, allocation, or retrieval of system resources. The device driver may include, for example, a display driver, a camera driver, a Bluetooth driver, a shared memory driver, a USB driver, a keypad driver, a Wi-Fi driver, an audio driver, or an inter-process communication (IPC) driver.

According to an embodiment, the framework may include, for example, a wireless communication module (e.g., Wi-Fi or Bluetooth), and without being limited thereto, the framework may further include other modules. The framework may provide functions commonly required by applications, or provide various functions to applications via an application programming interface (API) (not illustrated) so as to enable the applications to efficiently use limited system resources within the electronic device. The wireless communication module may manage, for example, a wireless connection of the wireless communication scheme (e.g., Wi-Fi or Bluetooth). The framework may include a module that forms a combination of various functions of the aforementioned components. The framework may provide a module specialized for each type of operating system in order to provide differentiated functions. The framework may dynamically delete some of existing components or add new components.

According to an embodiment, the applications may include an application (e.g., a module, a manager, or a program) related to location estimation of a wireless signal. The applications may further include a module (or application) (not illustrated) for wireless communication with an external electronic device (e.g., the electronic device 102 or 104 and/or the server 108 of FIG. 1, or the wearable device 201 and the target electronic device 203 of FIG. 2). The applications may include an application received from the external electronic device (e.g., the server 108 or the electronic device 102 or 104). According to an embodiment, the applications may include a preloaded application or a third-party application downloadable from the server. The illustrated components of the software module according to the embodiment and names of the components may vary depending on a type of an operating system. According to an embodiment, at least a part of the software module may be implemented as software, firmware, hardware, or a combination of at least two or more thereof. The at least a part of the software module 201 may be implemented (e.g., executed) by, for example, a processor (e.g., an AP). The at least a part of the software module may include, for example, a module, a program, a routine, a set of instructions, or a process for performing at least one function.

In this way, in an embodiment, the main components of the electronic device 101 of FIGS. 1 and 2 have been described. In various embodiments, not all of the components illustrated via FIGS. 1 and 2 are essential components, and the electronic device 101 may be implemented by more components or may be implemented by fewer components than the illustrated components. The locations of the main components of the electronic device 101 described above via FIGS. 1 and 2 may be changeable according to various embodiments.

According to an embodiment, an electronic device (e.g., the electronic device 101 of FIGS. 1 to 6) may include an antenna circuit (e.g., the antenna module 197 of FIG. 1 and the antenna circuit 230 of FIG. 2), a communication circuit (e.g., the communication module 190 of FIG. 1 and the communication circuit 220 of FIG. 2), memory (e.g., the memory 130 of FIG. 1 and the memory 240 of FIG. 2), and at least one processor (e.g., the processor 120 of FIG. 1 and the processor 210 of FIG. 2) operatively connected to the antenna circuit, the communication circuit, and the memory.

According to an embodiment, the at least one processor may be configured to receive a wireless signal transmitted in a wireless communication scheme by a target electronic device (e.g., the target electronic device 203 of FIG. 2).

According to an embodiment, the at least one processor may be configured to acquire first information on a wireless signal received by an external electronic device at a first location and a first distance value between the first location of the external electronic device and a fixed location of the electronic device, by instructing the external electronic device, which receives the wireless signal transmitted by the target electronic device, to be located at the first location in a first direction.

According to an embodiment, the at least one processor may be configured to acquire a first AoA based on the first distance value and the first information.

According to an embodiment, the at least one processor may be configured to acquire second information on a wireless signal received by the external electronic device at a second location and a second distance value between the second location of the external electronic device and the fixed location of the electronic device by instructing the external electronic device to be located at the second location in a second direction different from the first direction.

According to an embodiment, the at least one processor may be configured to acquire a second AoA based on the second distance value and the second information.

According to an embodiment, the at least one processor may be configured to, based on the first AOA and the second AOA, acquire three-dimensional location information corresponding to a transmission location of the wireless signal transmitted by the target electronic device so as to identify a location of the target electronic device.

According to an embodiment, the at least one processor may be configured to provide a first message instructing the external electronic device to be located at the first location in the first direction, and to provide a second message instructing the external electronic device to be located at the second location in the second direction.

According to an embodiment, the antenna circuit includes a single antenna configured to be used to measure a transmission location of the wireless signal, and may configured to receives, via the single antenna, the wireless signal transmitted from the target electronic device.

According to an embodiment, the wireless signal may be a Wi-Fi signal or a Bluetooth signal.

According to an embodiment, the external electronic device may be a wearable device or a mobile wireless communication device configured to receive the wireless signal via the single antenna configured to be used to measure the transmission location of the wireless signal.

According to an embodiment, the electronic device may further include a display (e.g., the display module 160 of FIG. 1 and the display 250 of FIG. 2).

According to an embodiment, the at least one processor may be configured to identify a location of the target electronic device based on the three-dimensional location information, and control the display to display an execution screen including a graphic object indicating the identified location.

According to an embodiment, the electronic device may further include an audio output circuit (e.g., the audio output module 155 of FIG. 1 and the audio output circuit 260 of FIG. 2). According to an embodiment, the at least one processor may be configured to identify the location of the target electronic device based on the three-dimensional location information, and control the audio output circuit to output speech information indicating the identified location.

According to an embodiment, the first direction may be the x-axis direction or the horizontal direction based on the fixed location. According to an embodiment, the second direction may be the y-axis direction or the vertical direction based on the fixed location.

According to an embodiment, the first information may include at least one of identification information, phase information, a signal measurement time, or a signal strength of a wireless signal received at a first time point at the first location of the external electronic device.

According to an embodiment, the second information may include at least one of identification information, phase information, a signal measurement time, or a signal strength of a wireless signal received at a second time point at the second location of the wearable device.

According to an embodiment, the at least one processor may be configured to acquire the first AoA by using a time difference or a phase difference, a signal speed, and the first distance value for the wireless signal received at the first time point at the first location, and to acquire the second AoA by using a time difference or a phase difference, a signal speed, and the second distance value for the wireless signal received at the second time point at the second location.

According to an embodiment, the first distance value and the second distance value may be acquired using a received signal strength indicator (RSSI).

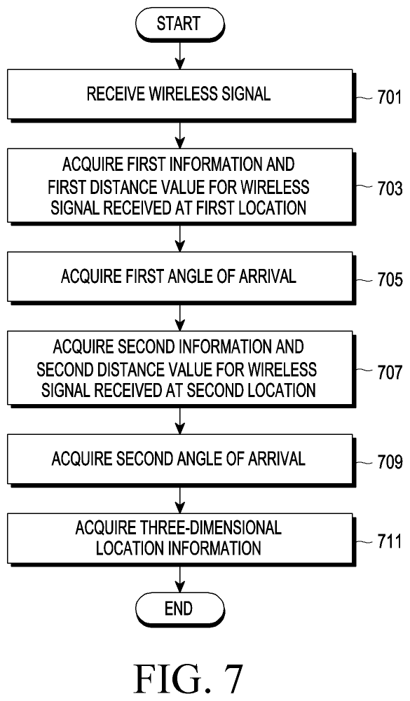

FIG. 7 is a diagram illustrating an example of an operation method of an electronic device according to an embodiment. In the following embodiments, respective operations may be sequentially performed, but are not necessarily performed sequentially. For example, the order of the respective operations may be changed, and at least two operations may be performed in parallel.

Referring to FIG. 7, an electronic device (e.g., the electronic device 101 of FIGS. 1 and 2) according to an embodiment may perform communication with a target electronic device (e.g., the target electronic device 203 of FIG. 3) and an external electronic device (e.g., the external electronic device 201 of FIGS. 3 and 4A) in operation 701 by using a wireless communication scheme. The electronic device may receive a wireless signal from the target electronic device by using the wireless communication scheme. The external electronic device may receive the wireless signal transmitted by the target electronic device. For example, the wireless communication scheme may be short-range wireless communication (e.g., a Wi-Fi or Bluetooth scheme).

In operation 703, the electronic device according to an embodiment may induce (e.g., instruct) the wearable device to move to a first location in a first direction, thereby acquiring first information on a wireless signal received by the external electronic device at the first location and a first distance value between the first location of the external electronic device and a fixed location of the electronic device.

In operation 705, the electronic device according to an embodiment may acquire a first angle θ1 of arrival (AOA) of the wireless signal, based on the first distance value and the first information on the wireless signal received from the wearable device. Here, the first AOA may be an angle between a reference direction and a direction (e.g., the first direction) in which the wireless signal received via an antenna of the wearable device at the first location arrives. The electronic device according to an embodiment may acquire the first AoA θ1 by using a time difference Δt (e.g., a difference between a time for arrival at the single antenna of the external electronic device and a time for arrival at the single antenna of the electronic device) or a phase difference, a signal speed c, and a first distance value d1 for a wireless signal received at a first time point at the first location. The first AoA θ1 may be calculated using <Equation 1>.

In operation 707, the electronic device according to an embodiment may induce the wearable device to move to a second location in a second direction, thereby acquiring second information on a wireless signal received by the external electronic device at the second location and a second distance value between the second location of the external electronic device and the fixed location of the electronic device.

In operation 709, the electronic device according to an embodiment may acquire a second AOA θ2 of the wireless signal, based on the second distance value and the second information on the wireless signal received from the wearable device. Here, the second AOA may be an angle between the reference direction and a direction (e.g., the second direction) in which the wireless signal received via the antenna of the wearable device at the second location arrives. The electronic device according to an embodiment may acquire the second AoA θ2 by using a time difference Δt (e.g., a difference between a time for arrival at the single antenna of the external electronic device and a time for arrival at the single antenna of the electronic device) or a phase difference, a signal speed c, and a second distance value d2 for a wireless signal received at the second time point at the second location. The second AoA θ2 may be calculated using <Equation 2>.

In operation 711, based on the first AoA and the second AoA, three-dimensional location information (e.g., a spherical coordinate system (r, θ1, θ2)) of the direction in which the wireless signal is transmitted may be acquired.

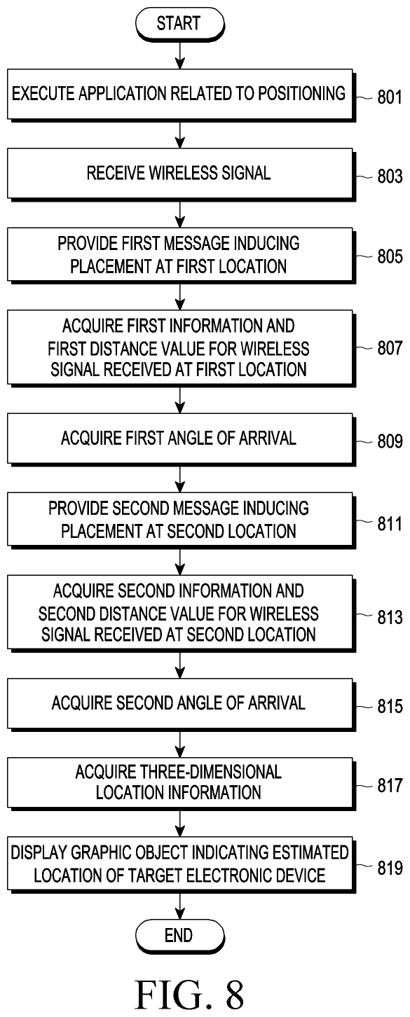

FIG. 8 is a diagram illustrating an example of an operation method of an electronic device according to an embodiment. In the following embodiments, respective operations may be sequentially performed, but are not necessarily performed sequentially. For example, the order of the respective operations may be changed, and at least two operations may be performed in parallel.

Referring to FIG. 8, an electronic device (e.g., electronic device 101 of FIGS. 1 and 2) according to an embodiment may execute, in operation 801, an application related to positioning in response to a request for measuring (e.g., identifying, gauging, detecting, or estimating) a location of a target electronic device.

In operation 803, the electronic device according to an embodiment may perform communication with the target electronic device and a wearable device by using a wireless communication scheme. According to an embodiment, the electronic device may receive a wireless signal from the target device by using the wireless communication scheme. The wearable device may receive the wireless signal transmitted by the target electronic device. For example, the wireless communication scheme may be short-range wireless communication (e.g., a Wi-Fi or Bluetooth scheme).

In operation 805, the electronic device according to an embodiment may display, on an execution screen (e.g., the first execution screen 510 of FIG. 3), a first message (e.g., the message 311 of FIG. 3) (e.g., “attach your smartwatch to your smartphone and move the smartwatch slowly as follows”) that induces the wearable device to move to (or be located at) a first location in a first direction and/or an image that induces the wearable device to be located at the first location in the first direction. Here, the message may be output as speech information by using an audio output device of the electronic device, and without being limited thereto, the message may be output using vibration or light.

In operation 807, based on the wearable device having moved to the first location, the electronic device according to an embodiment may acquire (or receive), from the external electronic device, first information on a wireless signal received at the first location, and may acquire a first distance value between the first location of the external electronic device and a fixed location of the electronic device.

In operation 809, the electronic device according to an embodiment may acquire a first AOA θ1 based on the first distance value and the first information. Here, the first AOA may be an angle between a reference direction and a direction (e.g., the first direction) in which the wireless signal received via an antenna of the wearable device at the first location arrives. The electronic device according to an embodiment may acquire the first AoA 74 1 by using a time difference Δt (e.g., a difference between a time for arrival at the single antenna of the external electronic device and a time for arrival at the single antenna of the electronic device) or a phase difference, a signal speed c, and a first distance value d1 for a wireless signal received at a first time point at the first location. The first AoA θ1 may be calculated using <Equation 1>.

In operation 811, the electronic device according to an embodiment may display, on an execution screen (e.g., the second execution screen 520 of FIG. 3), a second message (e.g., the message 521 of FIG. 3 (“slowly move the smartwatch upward while holding the smartphone still”)) that induces the external electronic device to move to (or be located at) the second location in the second direction and/or an image that induces the external electronic device to be located at the second location in the second direction. Here, the second message may be output as speech information by using an audio output device of the electronic device, and without being limited thereto, the second message may be output using vibration or light.

In operation 813, based on the external electronic device having moved to the second location, the electronic device according to an embodiment may acquire (or receive), from the external electronic device, second information on a wireless signal received at the second location, and may acquire a second distance value between the second location of the external electronic device and the fixed location of the electronic device.

In operation 815, the electronic device according to an embodiment may acquire a second AOA θ2 based on the second distance value and the second information. Here, the second AOA may be an angle between the reference direction and a direction (e.g., the second direction) in which the wireless signal received via the antenna of the wearable device at the second location arrives. The electronic device according to an embodiment may acquire the second AoA θ2 by using a time difference Δt (e.g., a difference between a time for arrival at the single antenna of the external electronic device and a time for arrival at the single antenna of the electronic device) or a phase difference, a signal speed c, and a second distance value d2 for a wireless signal received at the second time point at the second location. The second AoA θ2 may be calculated using <Equation 2>.

In operation 817, based on the first AoA and the second AoA, three-dimensional location information (e.g., a spherical coordinate system (r, θ1, θ2)) of the direction in which the wireless signal is transmitted may be acquired.

In operation 819, the electronic device according to an embodiment may display a graphic object (e.g., text or symbol) indicating an estimated location of the target electronic device on a display, based on the acquired three-dimensional location information (e.g., the spherical coordinate system (r, θ1, ∝2)). For example, as in the third execution screen 610 illustrated in FIG. 6, the electronic device may display the graphic object 611 or 613 indicating the estimated location of the target electronic device. According to an embodiment, the electronic device may display an execution screen that displays at least one of a virtual reality space, an image, or a map for a place including the estimated location of the target electronic device, and may display the graphic object 611 or 613 indicating the estimated location of the target electronic device on the displayed execution screen. Without being limited thereto, the electronic device according to an embodiment may provide, as speech information, the estimated location of the target electronic device.

The electronic device according to an embodiment may transmit the acquired three-dimensional location information (e.g., the spherical coordinate system (r, θ1, θ2)) to the external electronic device (e.g., the electronic device 102 or 104 or the server 108 of FIG. 1). According to an embodiment, the external electronic device may provide the estimated location of the target electronic device (e.g., display the graphic object indicating the estimated location or output the speech information), based on the received three-dimensional location information.

An electronic device according to an embodiment may identify (e.g., measure or estimate), by the operation methods described in FIGS. 7 and 8, a location of a target electronic device or a user carrying the target electronic device, which is unknown.

According to an embodiment, an operation method of an electronic device (e.g., the electronic device 101 of FIGS. 1 to 6) may include receiving a wireless signal transmitted in a wireless communication scheme by a target electronic device (e.g., the target electronic device 203 of FIG. 3).

According to an embodiment, the method may include acquiring first information on a wireless signal received by an external electronic device at the first location and a first distance value between a first location of the external electronic device and a fixed location of the electronic device, by instructing the external electronic device 201, which receives the wireless signal transmitted by the target electronic device, to be located at the first location in a first direction.

According to an embodiment, the method may include acquiring a first AoA based on the first distance value and the first information.

According to an embodiment, the method may include acquiring second information on a wireless signal received by the external electronic device at a second location and a second distance value between the second location of the external electronic device and the fixed location of the electronic device, by instructing the external electronic device to be located at the second location in a second direction different from the first direction.

According to an embodiment, the method may include acquiring a second AoA based on the second distance value and the second information.

According to an embodiment, the method may include, based on the first AOA and the second AOA, acquiring three-dimensional location information corresponding to a transmission location of the wireless signal transmitted by the target electronic device so as to identify a location of the target electronic device.

According to an embodiment, the method may further include providing a first message instructing the external electronic device to be located at the first location in the first direction, and providing a second message instructing the external electronic device to be located at the second location in the second direction.

According to an embodiment, the wireless signal may be received via a single antenna of the electronic device, which is used to measure a transmission location of the wireless signal, and the wireless signal may be a Wi-Fi signal or a Bluetooth signal.

According to an embodiment, the external electronic device may be a wearable device or a mobile wireless communication device which receives the wireless signal via a single antenna used to measure the transmission location of the wireless signal.

According to an embodiment, the method may further include identifying a location of the target electronic device based on the three-dimensional location information, and displaying, on a display of the electronic device, an execution screen including a graphic object indicating the identified location.

According to an embodiment, the method may further include identifying the location of the target electronic device based on the three-dimensional location information, and outputting speech information indicating the identified location via an audio output circuit (e.g., the audio output module 155 of FIG. 1 and the audio output circuit 260 of FIG. 2) of the electronic device.

According to an embodiment, the first direction may be the x-axis direction or the horizontal direction based on the fixed location, and the second direction may be the y-axis direction or the vertical direction based on the fixed location.

According to an embodiment, the first information may include at least one of identification information, phase information, a signal measurement time, or a signal strength of a wireless signal received at a first time point at the first location of the external electronic device.

According to an embodiment, the second information may include at least one of identification information, phase information, a signal measurement time, or a signal strength of a wireless signal received at a second time point at the second location of the wearable device.

According to an embodiment, the acquiring of the first AoA may include acquiring the first AoA by using a time difference or a phase difference, a signal speed, and the first distance value for the wireless signal received at the first time point at the first location.

According to an embodiment, the acquiring of the second AoA may include acquiring the second AoA by using a time difference or a phase difference, a signal speed, and the second distance value for the wireless signal received at the second time point at the second location.

According to an embodiment, the first distance value and the second distance value may be acquired using a received signal strength indicator (RSSI).

According to an embodiment, in a non-transitory storage medium for storing one or more programs, the one or more programs may include instructions, when executed by at least one processor (e.g., the processor 120 of FIG. 1 and the processor 210 of FIG. 2) of an electronic device (e.g., the electronic device 101 of FIGS. 1 to 6), causing the electronic device to perform: receiving a wireless signal transmitted in a wireless communication scheme by a target electronic device (e.g., the target electronic device 203 of FIG. 3); acquiring first information on a wireless signal received by an external electronic device at the first location and a first distance value between a first location of the external electronic device and a fixed location of the electronic device, by instructing the external electronic device (e.g., the external electronic device 201 of FIG. 3), which receives the wireless signal transmitted by the target electronic device, to be located at the first location in a first direction; acquiring a first AOA based on the first distance value and the first information; acquiring second information on a wireless signal received by the external electronic device at a second location and a second distance value between the second location of the external electronic device and the fixed location of the electronic device, by instructing the external electronic device to be located at the second location in a second direction different from the first direction; based on the second distance value and the second information, acquiring a second AOA based on the second distance value and the second information; and based on the first AOA and the second AOA, acquiring three-dimensional location information corresponding to a transmission location of the wireless signal transmitted by the target electronic device so as to identify a location of the target electronic device.

The disclosure may include: using a distance of different locations between the electronic device and the external electronic device which receive the wireless signal for positioning via single antennas thereof, and sharing information on the wireless signal received in each of the devices, thereby acquiring angles of arrival (e.g., the first AoA and the second AoA) for the different locations; based on the angles of arrival (e.g., the first AoA and the second AoA) for the different locations, measuring the transmission location of the wireless signal transmitted by the target electronic device; and estimating the location of the target electronic device based on the three-dimensional location information corresponding to the measured transmission location. The disclosure may include displaying information on the location of the target electronic device, which has been estimated based on the three-dimensional location information, to a user or providing the information as speech information to the user, thereby enabling the location of the target electronic device to be more conveniently and easily identified.

Various other effects understood directly or indirectly through the disclosure may be provided. Advantageous effects obtainable from the disclosure may not be limited to the above-mentioned effects, and other effects which are not mentioned may be clearly understood from the following descriptions by those skilled in the art to which the disclosure pertains.

Furthermore, the embodiments disclosed herein have been presented to explain the technical contents of the disclosure and help the understanding thereof, and are not intended to limit the scope of the technology disclosed herein. Therefore, the scope of the disclosure should be construed to cover all changes and modifications or various other embodiments based on the technical idea of the disclosure.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments. operations performed by the module. the program, or another component may be carried out sequentially, in parallel. repeatedly, or heuristically, or one or more of the operations may be executed in a different order or omitted, or one or more other operations may be added.

What is claimed is:

1. An electronic device comprising:
an antenna circuit;
a communication circuit;
memory storing one or more instructions; and
at least one processor configured to execute the one or more instructions to:
receive a wireless signal transmitted based on a wireless communication scheme by a target electronic device;
acquire first information associated with the wireless signal received by an external electronic device at a first location;
determine a first distance value between the first location of the external electronic device and a fixed location of the electronic device, by instructing the external electronic device to be located at the first location in a first direction;
acquire a first angle of arrival, based on the first distance value and the first information;
acquire second information associated with the wireless signal received by the external electronic device at a second location;
determine a second distance value between the second location of the external electronic device and the fixed location of the electronic device, by instructing the external electronic device to be located at the second location in a second direction that is different from the first direction;
acquire a second angle of arrival, based on the second distance value and the second information;
acquire, based on the first angle of arrival and the second angle of arrival, three-dimensional location information corresponding to a transmission location of the wireless signal transmitted by the target electronic device; and
identify a location of the target electronic device based on the three-dimensional location information.

2. The electronic device of claim 1, wherein the at least one processor is configured to:
provide a first message instructing the external electronic device to be located at the first location in the first direction; and
provide a second message instructing the external electronic device to be located at the second location in the second direction.

3. The electronic device of claim 1,
wherein the antenna circuit comprises a single antenna,
wherein the single antenna is configured to receive the wireless signal transmitted by the target electronic device and measure the transmission location of the wireless signal,
wherein the wireless signal is a Wi-Fi signal or a Bluetooth signal, and
wherein the external electronic device is a wearable device or a mobile wireless communication device comprising a single antenna that is configured to receive the wireless signal and measure the transmission location of the wireless signal.

4. The electronic device of claim 1, further comprising a display,
wherein the at least one processor is further configured to identify the location of the target electronic device, based on the three-dimensional location information, and control the display to display an execution screen comprising a graphic object indicating the identified location of the target electronic device.

5. The electronic device of claim 1, further comprising an audio output circuit,
wherein the at least one processor is further configured to identify the location of the target electronic device, based on the three-dimensional location information, and control the audio output circuit to output speech information indicating the identified location of the target electronic device.

6. The electronic device of claim 1, wherein the first direction corresponds to an x-axis direction or a horizontal direction, based on the fixed location of the electronic device, and
wherein the second direction corresponds to a y-axis direction or a vertical direction, based on the fixed location.

7. The electronic device of claim 1, wherein the first information comprises at least one of identification information, phase information, a signal measurement time, or a signal strength of the wireless signal received at a first time point at the first location of the external electronic device, and
wherein the second information comprises at least one of identification information, phase information, a signal measurement time, or a signal strength of the wireless signal received at a second time point at the second location of the external electronic device.

8. The electronic device of claim 1, wherein the at least one processor is further configured to:
acquire the first angle of arrival based on at least one of a time difference or a phase difference, a signal speed, and the first distance value; and
acquire the second angle of arrival based on at least one of a time difference or a phase difference, a signal speed, and the second distance value.

9. The electronic device of claim 1, wherein the first distance value and the second distance value are acquired based on a received signal strength indicator (RSSI).

10. An operation method of an electronic device, the method comprising:
receiving a wireless signal transmitted based on a wireless communication scheme by a target electronic device;
acquiring first information associated with the wireless signal received by an external electronic device at a first location;
determining a first distance value between the first location of the external electronic device and a fixed location of the electronic device, by instructing the external electronic device to be located at the first location in a first direction;
acquiring a first angle of arrival, based on the first distance value and the first information;
acquiring second information associated with the wireless signal received by the external electronic device at a second location;
determining a second distance value between the second location of the external electronic device and the fixed location of the electronic device, by instructing the external electronic device to be located at the second location in a second direction that is different from the first direction;
acquiring a second angle of arrival, based on the second distance value and the second information;
acquiring, based on the first angle of arrival and the second angle of arrival, three-dimensional location information corresponding to a transmission location of the wireless signal transmitted by the target electronic device;
identifying a location of the target electronic device based on the three-dimensional location information.

11. The method of claim 10, further comprising:
providing a first message instructing the external electronic device to be located at the first location in the first direction; and
providing a second message instructing the external electronic device to be located at the second location in the second direction.

12. The method of claim 10,
wherein the wireless signal is received via a single antenna of the electronic device, wherein the single antenna is configured to measure the transmission location of the wireless signal,
wherein the wireless signal is a Wi-Fi signal or a Bluetooth signal, and
wherein the external electronic device is a wearable device or a mobile wireless communication device comprising a single antenna that is configured to receive the wireless signal and measure the transmission location of the wireless signal.

13. The method of claim 10, further comprising:
identifying the location of the target electronic device, based on the three-dimensional location information; and
displaying an execution screen comprising a graphic object indicating the identified location of the target electronic device on a display of the electronic device.

14. The method of claim 10, further comprising:
identifying the location of the target electronic device, based on the three-dimensional location information; and
outputting speech information indicating the identified location of the target electronic device via an audio output circuit of the electronic device.

15. The method of claim 10, wherein the first direction corresponds to an x-axis direction or a horizontal direction based on the fixed location of the electronic device, and
wherein the second direction corresponds to a y-axis direction or a vertical direction, based on the fixed location.

16. The method of claim 10, wherein the first information comprises at least one of identification information, phase information, a signal measurement time, or a signal strength of the wireless signal received at a first time point at the first location of the external electronic device, and
wherein the second information comprises at least one of identification information, phase information, a signal measurement time, or a signal strength of the wireless signal received at a second time point at the second location of the external electronic device.

17. The method of claim 10, wherein the acquiring of the first angle of arrival comprises acquiring the first angle of arrival based on at least one of a time difference or a phase difference, a signal speed, and the first distance value.

18. The method of claim 10, wherein the acquiring of the second angle of arrival comprises acquiring the second angle of arrival based on at least one of a time difference or a phase difference, a signal speed, and the second distance value.

19. The method of claim 10, wherein the first distance value and the second distance value are acquired based on a received signal strength indicator (RSSI).

20. A non-transitory storage medium for storing one or more instructions which, when executed by at least one processor of an electronic device, cause the electronic device to perform:
receiving a wireless signal transmitted based on a wireless communication scheme by a target electronic device;
acquiring first information associated with the wireless signal received by an external electronic device at a first location;
determining a first distance value between the first location of the external electronic device and a fixed location of the electronic device, by instructing the external electronic device to be located at the first location in a first direction;
acquiring a first angle of arrival, based on the first distance value and the first information;
acquiring second information associated with the wireless signal received by the external electronic device at a second location;
determining a second distance value between the second location of the external electronic device and the fixed location of the electronic device, by instructing the external electronic device to be located at the second location in a second direction that is different from the first direction;
acquiring a second angle of arrival, based on the second distance value and the second information;
acquiring, based on the first angle of arrival and the second angle of arrival, three-dimensional location information corresponding to a transmission location of the wireless signal transmitted by the target electronic device;
identifying a location of the target electronic device based on the three-dimensional location information.
